(19) United States
(12) Patent Application Publication
(10) Pub. No.: US 2019/0001572 A1
(43) Pub. Date: Jan. 3, 2019

(54) METHODS AND APPARATUS FOR MANUFACTURING A COMPONENT

(71) Applicant: ROLLS-ROYCE plc, London (GB)

(72) Inventors: David SAVINGS, Nottingham (GB); Ross TREPLETON, Water Orton (GB)

(21) Appl. No.: 16/016,753

(22) Filed: Jun. 25, 2018

(30) Foreign Application Priority Data
Jun. 30, 2017 (GB) 1710486.0

(51) Int. Cl. B29C 64/30; B29C 64/153; B29C 33/60; B29C 33/44; B22F 3/105; B22F 3/12; B22F 3/15; B29C 64/245; B33Y 10/00; B33Y 30/00

(52) U.S. Cl. CPC B29C 64/30; B29C 64/153; B29C 33/60; B29C 33/44; B22F 3/1055; B22F 2003/1056; B22F 3/15; B29C 64/245; B33Y 10/00; B33Y 30/00; B22F 3/1208

(57) ABSTRACT

A method of manufacturing a component comprising contacting a powder with a tooling comprising a main body and a removable element, applying a manufacturing process to the powder to form the powder into a component, removing the removable element from the tooling to form a recess, and inserting a separation tool into the recess to thereby apply a force to separate the component from the main body of the tooling. A tooling for forming a component from a powder, the tooling comprising a main body and a removable element which is removable from the main body to form a recess for the insertion of a separation tool to apply a force to separate the component from the main body of the tooling.

### CROSS-REFERENCE TO RELATED APPLICATIONS

This specification is based upon and claims the benefit of priority from UK Patent Application Number 1710486.0 filed on 30 Jun. 2017, the entire contents of which are incorporated herein by reference.

### BACKGROUND

### Technical Field

The present disclosure concerns a method of manufacturing a component and, in particular although not exclusively, a method of forming a component using powder.

### Description of the Related Art

It is known to manufacture components from powder materials, such as powdered metals or ceramics. A number of methods are available to form solid components from powders, and the chosen method depends upon the required properties of the component and the available budget.

Often, in powder manufacturing processes, the component will become stuck or fused with any tooling in contact with the powder during the manufacturing process. For example, when laser sintering, the first layers to be sintered tend to fuse to the base plate, while, in hot isostatic pressing (HIP), the material of the canister tends to stick to the outer surface of the component. It will therefore be understood components must be separated from tooling after manufacture.

During separation of the component from the tooling, the latter will often be damaged or even intentionally sacrificed. However, the tooling itself may be expensive, time-consuming, and environmentally damaging to produce, so it is generally desirable to provide tooling which may be separated from powder formed components and re-used.

Therefore, it will be understood that improvements in tooling for powder manufacturing would be desirable.

### SUMMARY

According to a first aspect there is provided a method of manufacturing a component comprising contacting a powder with a tooling comprising a main body and a removable element, applying a manufacturing process to the powder to form the powder into a component, removing the removable element from the tooling to form a recess, and inserting a separation tool into the recess to thereby apply a force to separate the component from the main body of the tooling.

The tooling may be a device against which a surface of the component is formed. The powder may be a metal powder, a ceramic powder, an alloy powder, a polymer powder, or a composite powder.

The main body of the tooling may be a contiguous element, or may be formed from a plurality of separate elements.

The removal of the removable element may form a recess which is in communication with a surface of the component. The separation tool may be inserted into the recess to contact the surface of the component and apply a force to separate the component from the main body of the tooling. The recess may comprise a wedge-shaped recess or an elongate bore. The separation tool may comprise a portion substantially corresponding to the shape of the recess. The separation tool may comprise a tip or end portion which is softer than a material of the component such that the tool will not damage a surface of the component

The main body of the tooling may be in contact with a surface of the component. The tooling may further comprise a buffer element separable from the main body and in contact with the surface of the component. Removal of the removable element may form a recess which is in communication with the buffer element of the component. The separation tool may be inserted into the recess to contact the buffer element and apply a force to separate the main body of the tooling from the component. The buffer element may form a buffer or barrier between the powder and the removable element before or during the manufacturing process. The buffer element may be arranged to form a buffer between the separation tool and the component such that the separation tool does not directly contact the component when inserted into the recess.

The method may further comprise anchoring the component or the main part of the tooling during application of the force by the separation tool.

The removable element may be shaped such that the recess comprises an oblique tool contact surface. The tool contact surface may be oblique to an insertion direction of the tool, a longitudinal axis of the recess, or a direction of the applied force.

Inserting the separation tool may comprise contacting the separation tool with the oblique tool contact surface such that the applied force is transmitted to the tooling or the component in a direction oblique to a direction of the force applied to the tool. The force may be transmitted in a direction so as to oppose a force bonding the component to the main body of the tooling.

The separation tool comprises an oblique tool face corresponding to the tool contact surface of the recess. The oblique tool face may be arranged for sliding contact with the tool contact surface in a direction oblique to an insertion direction of the tool.

The removable element may have a first length. The separation tool may have a second length longer than the first length. The recess may have a depth less than the second length, or substantially equal to the first length.

The removable element may be an elongate element or a wedge-shaped element.

The component may comprise a cavity. The main body of the tooling may correspond to the shape of the cavity of the component. An outer surface of the main body may correspond to an inner surface of the cavity.

The tooling may be a canister for manufacturing a component by isostatic pressing. The tooling may form a part of a canister for manufacturing a component by isostatic pressing.

The tooling may be a base plate or part of a base plate for manufacturing a component by selective sintering, such as laser sintering In some examples, other energy sources may be utilised for selective sintering, such as an electron beam.

The method may further comprise applying an anti-stick coating to a surface of the tooling to be contacted with the powder.

The method may further comprise applying an anti-stick coating to one or more interfaces between the removable element and the component.

The method may further comprise applying an anti-stick coating to one or more interfaces between the removable element and the main body of the tooling.

In a second aspect, there is provided a tooling for forming a component from a powder, the tooling comprising a main body and a removable element which is removable from the main body to form a recess for the insertion of a separation tool to apply a force to separate the component from the main body of the tooling.

The tooling may have any of the features of the tooling herein described.

In a third aspect, there is provided an apparatus for manufacturing a component comprising a tooling as herein described and a separation tool for insertion into the recess of the tooling to thereby separate the component from the main body of the tooling as herein described.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a view of a manufacturing apparatus comprising a tooling;

FIG. 2a is a sectional view of the manufacturing apparatus of FIG. 1;

FIG. 2b is a sectional view of a component manufactured with the manufacturing apparatus of FIG. 1;

FIG. 2c is a further sectional view of a component manufactured with the manufacturing apparatus of FIG. 1;

FIG. 3 is a view of a further manufacturing apparatus comprising a tooling;

FIG. 4a is a sectional view of the manufacturing apparatus of FIG. 3;

FIG. 4b is a sectional view of a component manufactured with the manufacturing apparatus of FIG. 3;

FIG. 4c is a further sectional view of a component manufactured with the manufacturing apparatus of FIG. 3;

FIG. 5a is a view of a further manufacturing apparatus comprising a tooling; and

FIG. 5b is a sectional view of a component manufactured with the manufacturing apparatus of FIG. 5a;

### DETAILED DESCRIPTION

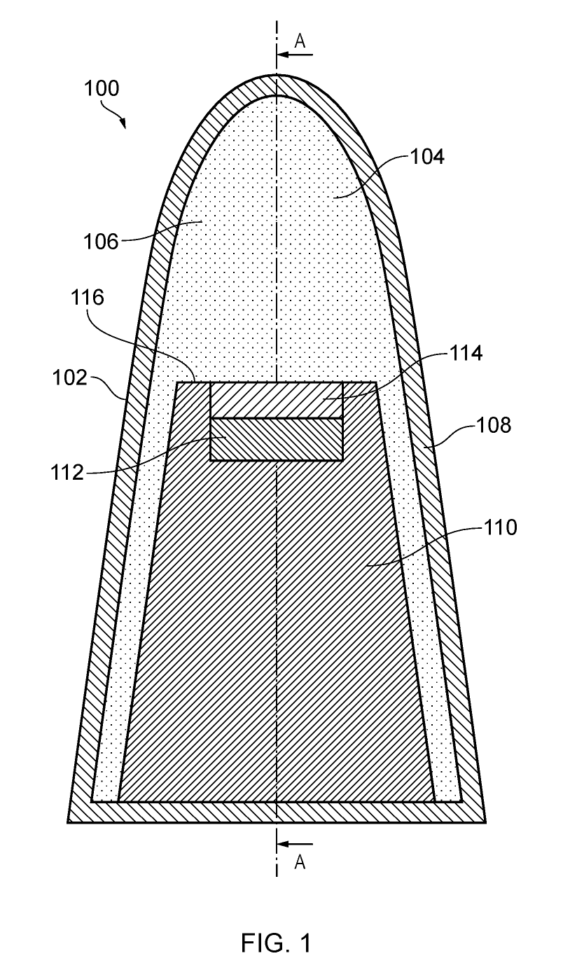

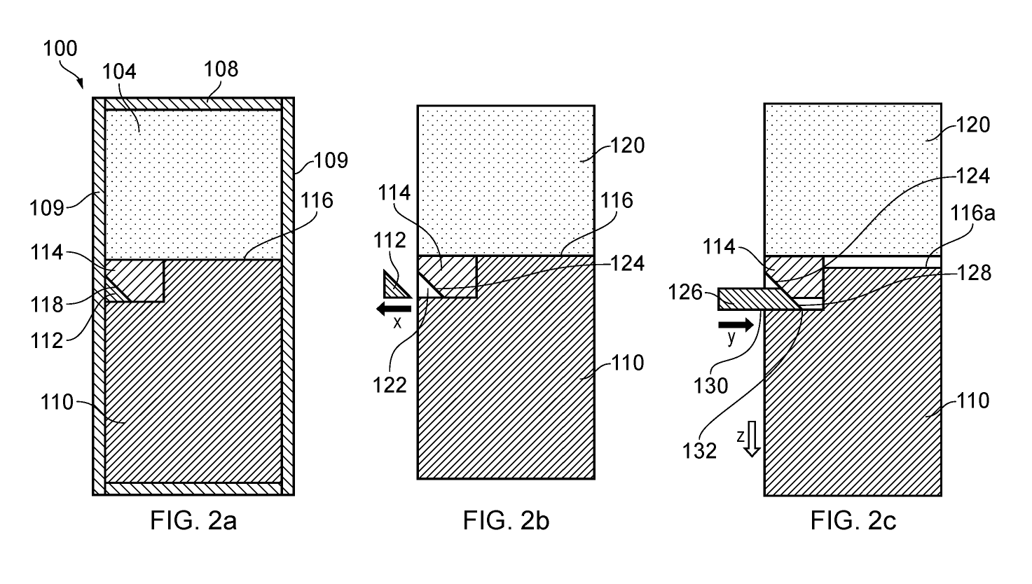

With reference to FIGS. 1 and 2a-c, a method of manufacturing a component will now be described. FIG. 1 shows a manufacturing apparatus 100. FIG. 2a shows a sectional view of the manufacturing apparatus 100 along the section line A-A of FIG. 1.

The manufacturing apparatus 100 comprises a tooling in the form of a canister 102, which surrounds a volume of powder 104. The canister 102 is a mould for forming a solid component from the powder 104 by a manufacturing process. In this case, the manufacturing process is hot isostatic pressing (HIP). The powder 104 may be a metal powder, a composite powder, a ceramic powder, a polymer powder, or an alloy powder.

The internal space 106 of the canister 102 is filled with powder 104, sealed, and then the canister 102 is placed into a high pressure, high temperature environment, such as an autoclave, for a predetermined period of time. The shape of the component following manufacturing substantially corresponds to the internal space 106 of the canister 102. The heat and pressure during the HIP process causes the powder 104 to diffusion bond into a conglomerated solid component. In addition, the powder 104 may, during the process, diffusion bond to the surface of the canister 102. Accordingly, the component may be bonded or ‘stuck’ to the canister 102.

The canister 102 comprises a shell 108 and a main body 110. The shell 108 defines an outer surface of the component. The main body 110 protrudes into the internal space 106 to form a cavity within the component. The shell 108 and the main body may be formed integrally, or may be formed separately and connected together, for example with welding or mechanical fixings. The shell 108 may be formed in several parts which may be welded or otherwise fixed together. The shell 108 also comprises end caps 109 (see FIG. 2). The end caps 109 are formed on the ends of the canister 102 to seal the internal space 106 containing the powder 104. For ease of understanding the end cap 109 is omitted from the view shown in FIG. 1. Accordingly, it should be understood that an end cap 109 of the shell 108 would be in contact with the surface shown in FIG. 1.

The canister 102 also comprises a removable element 112 and a buffer element 114. The removable element 112 and the buffer element 114 are engaged with the main body 110 of the canister 102. The buffer element 114 is in contact with the powder 104 within the internal space 106 of the canister 102. The buffer element 114 and the main body 110 of the canister 102 in combination define a cavity tooling surface 116 which is exposed to the powder 104 and defines the internal surface of the cavity of a component after the HIP process has been applied.

The removable element 112 is arranged in the canister 102 such that it is surrounded by the end cap 109, the buffer element 114, and the main body 110 such that the removable element 112 is not in contact with the powder 104. Accordingly, the buffer element 114 forms a buffer between the powder 104 and the removable element 112. The main body 110, the removable element 112, the buffer element 114 in combination define a portion of the canister 102 which forms a cavity in a component to be formed by a HIP process.

In some examples, an anti-stick coating may be applied to the cavity tooling surface 116, and to the interface surfaces between the main body 110, the removable element 112, and the buffer element 114 to prevent or reduce sticking of these components to the powder 104 or to each other.

Referring to FIG. 2, the removable element 112 comprises an oblique face 118 such that the removable element forms a generally wedge shape. The oblique face 114 contacts a corresponding face of the buffer element 114.

Turning now to FIG. 2b, a component 120 is shown. In order to form the component 120, a hot isostatic pressing (HIP) process was applied to the canister 102 containing the powder 104 as shown in FIGS. 1 and 2a. The powder 104 has bonded into a solid component 120, the shape of which corresponds broadly to the internal space 106 of the canister. In this case, the component 120 is a leading edge portion of a fan blade for a gas turbine engine. The methods and apparatus of the present disclosure may be particularly suitable to the manufacturing of components for aerospace applications or other high precision or high quality fields, as components produced by HIP and other powder forming methods may be near-net shape, saving costs on machining away the expensive material from which such components are formed.

During the HIP process, the powder 104 in contact with the canister 102 can diffusion bond to the material of the canister 102 such that the component 120 and the canister 102 are fused together at their interface. Accordingly, steps must be taken to separate the component 120 from the canister 102.

In FIG. 2b, the shell 108 of the canister 102 has already been removed. This can be performed by mechanical machining and/or chemical etching. It will be understood that the shell 108 is a relatively thin layer of material which can be relatively easily removed using these processes. In contrast, the main body 110 of the canister 102 is a significantly more massive, and it may not be feasible due to time or cost constraints to machine or etch away the main body 110.

Accordingly, the present disclosure provides a method which enables easy separation of the main body 110 from the component 120. This method in turn provides the advantage that the main body 110 may be recovered without damage and re-used to form canisters for the manufacture of other components of the same type.

As shown in FIG. 2b, the removable element 112 is removed from the remaining elements of the canister 102 (i.e. the buffer element 114 and the main body 110).

As mentioned, in some examples, the interfacing surfaces of the removable element 112, the buffer element 104, and the main body 110 may be provide with anti-stick coatings so that these parts do not diffusion bond to each other, thereby enabling easy removal of the removable element 112. Anti-stick coatings may be known as diffusion bonding barrier coatings. An example of such a coating may comprise yttria. In other examples, one or more of the removable element 112, the buffer element 104, and the main body 110 may be formed from material which is not readily diffusion bondable. Examples of such materials may be Al-, Fe-, Ni-, and Co-base alloys. In addition, the removable element 112, being of relatively small size compared to the buffer element 114 and the main body 110 has a smaller external contact area over which diffusion bonding may occur, so the removable element 112 may be relatively easier to remove than these larger components.

Accordingly, it will be understood that the removable element 112 may be relatively easily separated from the buffer element 114 and the main body 110 in the direction of the arrow x.

The removal of the removable element 112 from the canister 102 forms a recess 122 in the space previously occupied by the removable element 112. As the removable element 112 has a substantially wedge shape, the recess 122 has a corresponding wedge shape formed between the main body 110 and the buffer element 114.

Owing to the oblique face 118 of the removable element 112, the recess comprises a corresponding oblique face in the form of a tool contact surface 124. AS will be described below, the tool contact surface 124 is oblique to an insertion direction of a separation tool. The tool contact surface 124 is also oblique to the cavity tooling surface 116.

Turning now to FIG. 2c, the separation of the main body 110 from the component 120 will now be described.

Following removal of the removable element 112 and the resulting formation of the recess 122, the recess 122 can now be utilised to apply a force to separate the main body 110 of the canister 102 from the component 120.

A separation tool 126 is inserted into the recess 122. The separation tool 126 is inserted in a direction y and a force is applied to the tool in this direction y. Of course, as the force is applied to the buffer element 114 and the main body 110, to which the component 120 is attached, one of the component 120, or the main body 110 must be anchored down while the force is applied via the separation tool 126. In the below description, the process of separation will be described for the case where the component 120 is anchored down, while the remaining components of the canister 102 are not.

The separation tool 126 is elongate and comprises an oblique tool face 128 which corresponds to the tool contact surface 124 of the recess 122. An angle of the tool face 128 and the tool contact surface 124 is substantially similar such that the tip of the tool 126 fits snugly into the recess 122 and the tool face 128 and the tool contact surface 124 are in contact. The tool 126 also comprises a sliding face 130 which is substantially parallel to the direction y along which force is applied via the tool. The sliding face 130 of the tool contacts a corresponding sliding surface 132 of the main body 110. Accordingly, the tool 126, when inserted into the recess 122, contacts both the oblique tool contact face 124 on the buffer element 114 and the sliding surface 132 of the main body 110.

As the direction y in which the force is applied is oblique to the surface 124, the tool face 128 is predisposed to slide along the tool contact surface 124 in a direction parallel to the face 128 and generally away from the component 120. However, it may not slide in this direction as this is prevented by the contact of the sliding face 130 with the main body 110. The force applied to the tool 126 is therefore applied partially to the main body 110 in a direction z, which is perpendicular to the direction y and away from the component 120.

As the component 120 is anchored down, the force applied by the tool in direction z is acts on the main body 110 against the force of the bond between the main body 110 and the component 120 at the cavity tooling surface 116.

Thus, as the force applied to the tool in direction y increases, the corresponding force on the main body in the direction z also increases. At a certain point, one the force on the main body 110 in direction z is sufficient, the bonding force of the bonding between the main body 110 and the component 120 is overcome. Accordingly, the bond between the component 120 and the main body 110 is broken, and the two parts are thus separated.

It will be understood that in the case where the main body 110 is anchored instead of the component 110, the force applied by the tool 126 in direction y will act partially on the component 120 in a direction opposite to direction z, to thereby separate the component 120 from the anchored main body 110.

Of course, the buffer element 114 remains bonded to the component 120 despite the separation of the main body 110 from the component 120 by the tool 126. However, the size of the buffer element 114 itself and its area of contact with the component 120 are both relatively small compared to those of the main body 110. Accordingly, the buffer element 114 may be removed by mechanical means, such as by anchoring the component 120 and removing the buffer element 114 with plier grips, or by machining/chemical etching in the same manner as the shell 108 was removed.

It will be understood that the buffer element 114 is advantageous in that it prevents the removable element 112 from being in direct contact with the powder 104, thereby enabling easier removal of the removable element 112. Furthermore, the buffer element 114 also prevents the tool 126 from directly contacting the component 120 during the removal of the main body 110 from the component 120. Accordingly, the risk of the tool 126 damaging the component 120 while the separation force is applied is greatly reduced.

It should be understood however, that the buffer element 114 is not essential, as the recess formed by the removable element 112 could instead be formed directly between the component 120 and the main body 110, with the surface of the component forming either the sliding face 130 or the tool contact surface 124. However, in such cases, the direct contact of the tool 126 with the component 120 may result in damage to the component 120.

It will be understood that more than one removable element may be provided to permit the application or a separation force in multiple locations or to permit a tooling comprising multiple parts to be separated from a component piece-by-piece.

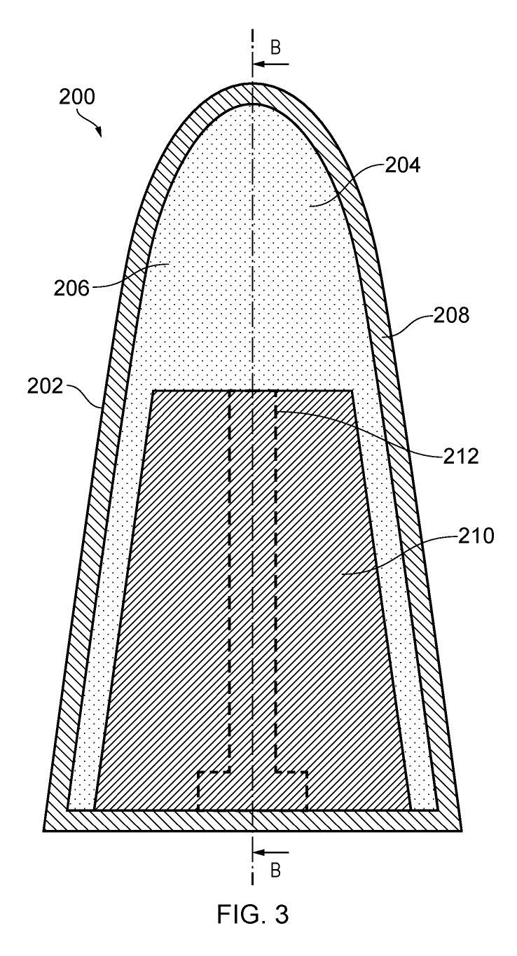

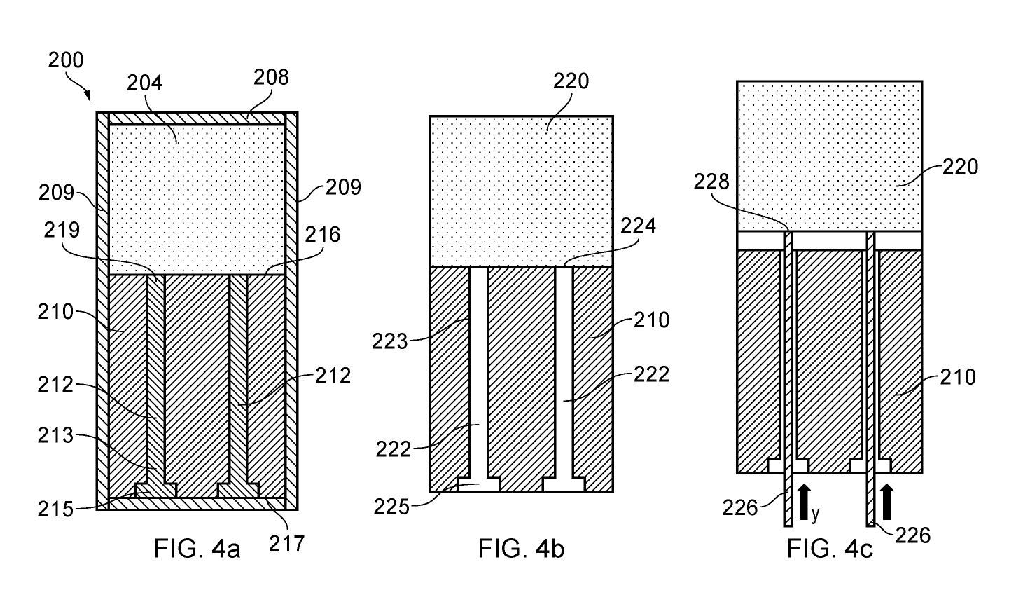

An alternative example of a method of manufacturing a component will now be described in relation to FIGS. 3 and 4a-c. Like features between the example of FIGS. 1 and 2a-c are illustrated and described with reference numerals differing by 100.

FIG. 3 and FIG. 4a show a manufacturing apparatus 200. The manufacturing apparatus comprises a canister 202 having an internal space 206 filled with powder 204.

Like the canister 102, the canister 202 comprises a shell 208, end caps 209, and a main body 210. The main body 210 houses a pair of removable elements 212. In FIG. 3, the end cap 209 is not shown to expose the main body 210, the powder 204. The location of the removable elements 212 is shown in dashed lines in FIG. 1. The removable elements 212 are generally located along a centreline of the apparatus 200, and evenly axially spaced along the apparatus as shown in FIG. 4a.

The removable elements 212 are elongate headed pins. The removable elements 212 comprise an elongate shaft 213 of a constant diameter having a head 215 at an end thereof. The head 215 has a diameter larger than the shaft 213.

The removable elements 212 are inserted into respective recesses 222 formed in the main body 210 (see FIG. 4b). The recesses 222 substantially correspond to the shapes of the removable elements 212. Each recess 222 therefore comprises an elongate bore 223 having a diameter substantially similar to the shaft 213 of the removable element 212, and a countersink 225 having a diameter and depth substantially similar to the diameter and depth of the head 215 of the removable elements 215.

Each recess 222 has a depth substantially identical to the length of the removable elements 212 such that the recesses 222 form a through bore from a shell-facing surface 217 of the main body 210 to the cavity tooling surface 216. Accordingly, when a removable element 212 is located in the recess 222, an end surface 219 of the shaft 213 is exposed to the powder 204 in the internal space 206, and the head 215 is entirely flush with the shell-facing surface 217. The head 215 of each removable element 212 prevents it from moving during the HIP process and extending into the internal space 206, which would result in a defective component.

As the removable elements 212 each comprise a head 215, they must be inserted into the recesses 22 from the shell-facing surface 217. Therefore, the removable elements 212 are inserted into the recesses 22 prior to fixing the main body 210 to the shell 208. Once the main body 210 is secured to the shell 208 by mechanical fixing, welding, or otherwise, the removable elements 212 are retained in the recesses 22 by the shell 208. Anti-stick coating may be applied to the shaft 213, head 215, and end surface 219 of the removable element 212 to prevent or inhibit the removable element 212 from sticking or bonding to the main body 210 or the powder 204. Alternatively, the removable elements may be manufactured from suitable material which has a reduced tendency to diffusion bond.

In other examples, a buffer element may be provided in the bore 223 between the end surface 219 of the removable element and the powder 214. In such cases, the buffer element may be secured using a shear pin or similar during the HIP process. A buffer element may provide the same advantages as the buffer element 114 described above.

The sealed canister 202 containing the powder 204 undergoes a HIP process as hereinbefore described and a component 220 is formed as shown in FIG. 4b. During the HIP process, the component 220 has bonded to the surface of the main body 210. As shown in FIG. 4b, the shell 208 has been removed by machining or etching, but the main body 210 remains bonded in the cavity of the component 220.

In FIG. 4b the removable elements 212 have been removed from the recesses 222 by mechanical force. The heads 215 of the removable elements 212 may comprise features which enable an extraction tool (not shown) to grip the elements 212 for their extraction from the recesses 222.

The recesses 222 are therefore open and form a through bore in the main body 210 which is capped at the cavity tooling surface 216 by the surface of the component 220. The area of the surface of the component 220 which forms the end of the recess 222 may be a tool contact area 224. The tool contact area 224 may be substantially perpendicular to an axis of the bore 223 of the recess 222.

In order to separate the component 220 from the main body 210 of the canister 202, a pair of separation tools 226 may be inserted into the recesses 222. The separation tools 226 are elongate members having a diameter substantially similar to or smaller than the bore 223. The separation tools 223 have a length greater than a total length of the removable elements 212 such that they can be inserted into the recesses to contact the tool contact areas 224 of the component 220. The end surface of each separation tool for contacting the tool contact area 224 of the component 220 is a contact face 228. The contact faces 228 may be formed of a material softer than the component 220 such that contacting the tool 226 with the component 220 does not damage the component's surface.

The separation tools 226 may be connected to a base member (not shown) such that force can be applied to both tools 226 simultaneously. In other examples, the tools 226 may be operated separately, for example by hand.

As shown in FIG. 4c, the main body 210 has been anchored while the component 220 is unanchored. The separation tools 226 have been inserted into the recesses 222 and the contact faces 228 engaged with the tool contact areas 224. A force is applied to the separation tools 226 in the direction y. As the main body 210 is anchored down, this force acts to urge the component 220 away from the main body 210 in the direction y. The force applied by the tools 226 is counteracted by the bonding force between the component 220 and the main body 210. However, once the force applied to the component 220 by the tools 226 is sufficiently large, the bond between the component 220 and the main body 210 will be broken, and the two part will be separated as shown in FIG. 4c.

It will be understood that more than one removable element may be provided to permit the application or a separation force in multiple locations or to permit a tooling comprising multiple parts to be separated from a component piece-by-piece.

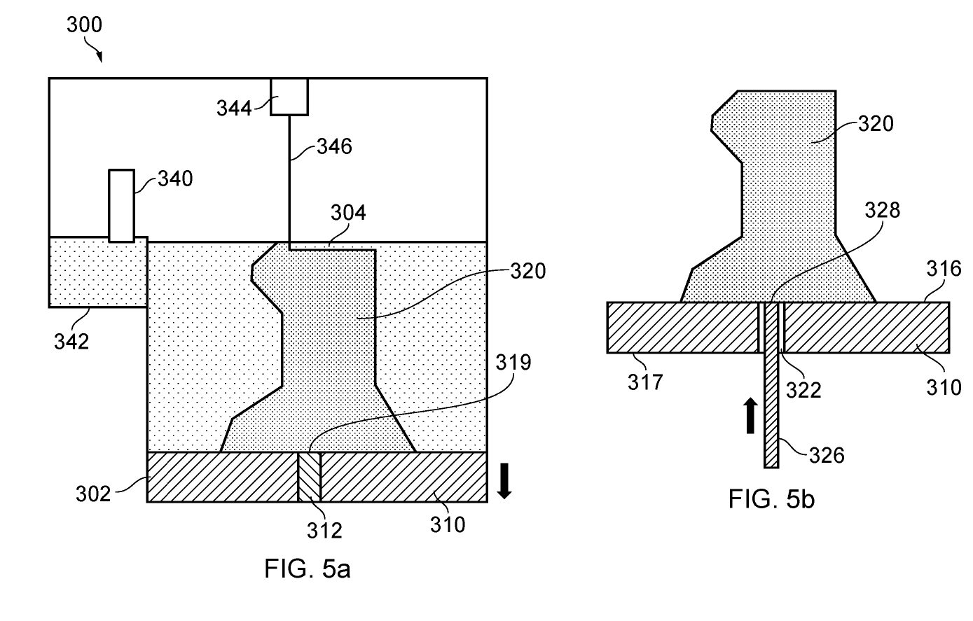

A third example of a manufacturing apparatus 300 applying the method of the present disclosure is illustrated in FIGS. 5a and 5b. Like features between the example of FIGS. 3 and 4a-c and the example of FIGS. 5a-b are shown in reference numerals separated by 100.

The apparatus 300 is a laser sintering apparatus. In laser sintering, a thin layer of powder 304 is spread across a tooling in the form of a base plate 302 by a spreader 340 from a powder reservoir 342. After the layer is spread across the base plate, an energy source 344 produces a laser beam 346 which is directed at the powder layer in a predetermined pattern to fuse the powder together to form a layer of a component 320.

The base plate 302 is then lowered by a small distance, and a further layer of powder 304 is spread on top of the previous layer by the spreader 340. The energy source 344 then fuses the fresh layer of powder 304 together and to the fused material in the previous layer in a predetermined pattern. The layering and fusing process is repeated to build a up a complete component 320 on the base plate 302 from a large number of thin slices, each formed from a thin layer of powder 304 which has been fused by the energy source 344.

In some cases, the first few layers of powder 304 to be deposited and fused may also be fused to the material of the base plate 302. Consequently, the entire component 320 may become fused to the base plate 302, and must be separated from the base plate 302 after the laser sintering process is complete.

In order to facilitate easy separation of the base plate 302 and the component 320 without destroying either part, the base plate comprises a main body portion 310 and a removable element 312.

The base plate comprises a recess 322 which extends from an underside 217 of the base plate 302 to a workpiece side 316 of the base plate 302 on which the component 320 is formed. The recess 322 is a substantially cylindrical bore having a constant internal diameter.

The removable element 312 is a dowel-shaped component substantially corresponding to the shape and size of the recess 322. The removable element may in some examples be secured in the recess by a screw-thread or by other mechanical means. An end surface 319 of the removable element may form a part of the workpiece surface 316 on which the component 320 is formed during the laser sintering process. The end surface 319 may be coated with an anti-stick coating or may be formed from an alloy which inhibits bonding to the powder 304 during laser sintering.

Before the laser sintering process, the removable element 312 is located and secured in the recess 322. The end surface 319 of the removable element 312 is flush with the workpiece surface 316 of the base plate 302.

The laser sintering process is then undertaken and the base of the component 320 may become fused to the base plate 302. In such cases, the removable element 312 can then be removed as shown in FIG. 5b to form the recess 322 which is in communication with the underside of the component 320.

The main part 310 of base plate 302 is anchored securely, and a separation tool 326 having a tool face 328 is inserted into the recess 322 to contact the component 320. A force is then applied to the component 320 which is sufficient to overcome the force of the bonding of the component 320 to the base plate 302. Accordingly, the component 320 is separated from the base plate 302.

It will be understood that the base plate 302 could comprise a plurality of recesses 322 and removable components 312 to enable force to be applied to separate the component 320 from the base plate 302 at multiple locations across the base plate 302.

The methods and apparatus of the present disclosure provide the advantages that a manufactured component may be separated from an associated tooling without damaging either part. Therefore, the tooling or a significant part thereof may be re-used in subsequent manufacturing operations. Embodiments of the present disclosure therefore provides a more efficient, quicker, and more environmentally friendly methods and apparatus for manufacturing components from powders.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of manufacturing a component comprising:
contacting a powder with a tooling comprising a main body and a removable element;
applying a manufacturing process to the powder to form the powder into a component;
removing the removable element from the tooling to form a recess; and
inserting a separation tool into the recess to thereby apply a force to separate the component from the main body of the tooling.

2. A method of manufacturing a component as claimed in claim 1, wherein the removal of the removable element forms a recess which is in communication with a surface of the component, and wherein the separation tool is inserted into the recess to contact the surface of the component and apply the force to separate the component from the main body of the tooling.

3. A method of manufacturing a component as claimed in claim 1, wherein the main body of the tooling is in contact with a surface of the component, the tooling further comprising a buffer element separable from the main body and in contact with the surface of the component, wherein removal of the removable element forms a recess which is in communication with the buffer element of the component, and wherein the separation tool is inserted into the recess to contact the buffer element and apply the force to separate the main body of the tooling from the component.

4. A method of manufacturing a component as claimed in claim 1, wherein the removable element is shaped such that the recess comprises an oblique tool contact surface.

5. A method of manufacturing a component as claimed in claim 4, wherein inserting the separation tool comprises contacting the separation tool with the oblique tool contact surface such that the applied force is transmitted to the tooling or the component in a direction oblique to a direction of the force applied to the tool.

6. A method of manufacturing a component as claimed in claim 4, wherein the separation tool comprises an oblique tool face corresponding to the tool contact surface of the recess.

7. A method of manufacturing a component as claimed in claim 1, wherein the removable element has a first length, the separation tool has a second length longer than the first length.

8. A method of manufacturing a component as claimed in claim 1 wherein the removable element is an elongate element or a wedge-shaped element.

9. A method of manufacturing a component as claimed in claim 1, wherein the component comprises a cavity and wherein the main body of the tooling corresponds to the shape of the cavity.

10. A method of manufacturing a component as claimed in claim 1, wherein the tooling is a canister for manufacturing a component by isostatic pressing.

11. A method of manufacturing a component as claimed in claim 1, wherein the tooling is a base plate for manufacturing a component by laser sintering.

12. A method of manufacturing a component as claimed in claim 1, further comprising applying an anti-stick coating to a surface of the tooling to be contacted with the powder.

13. A method of manufacturing a component as claimed in claim 1, further comprising applying an anti-stick coating to one or more interfaces between the removable element and the component.

14. A method of manufacturing a component as claimed in claim 1, further comprising applying an anti-stick coating to one or more interfaces between the removable element and the main body of the tooling.

15. A tooling for forming a component from a powder, the tooling comprising a main body and a removable element which is removable from the main body to form a recess for the insertion of a separation tool to apply a force to separate the component from the main body of the tooling.

16. An apparatus for manufacturing a component, the apparatus comprising a main body and a removable element which is removable from the main body to form a recess and a separation tool for insertion into the recess of the apparatus to thereby separate the component from the main body of the tooling.
